(19) United States
(12) Patent Application Publication
(10) Pub. No.: US 2010/0200275 A1
(43) Pub. Date: Aug. 12, 2010

(54) GAS INSULATED TRANSMISSION LINE HAVING IMPROVED PERFORMANCE OF ELECTRIC CONTACT AT CONNECTION PARTS OF THE CONDUCTORS

(76) Inventors: Sung-Yun Kim, Suseong-gu (KR); Seok-Hyun Nam, Gumi-si (KR); Sung-Ik Shim, Gangnam-gu (KR); Mi-Kyoung An, Nam-gu (KR); Sin-Woo Park, Nonsan-si (KR)

Correspondence Address: SHERR & VAUGHN, PLLC, 620 HERNDON PARKWAY, SUITE 320, HERNDON, VA, 20170, US

(21) Appl. No.: 12/566,018

(22) Filed: Sep. 24, 2009

(30) Foreign Application Priority Data
Feb. 11, 2009 (KR) 10-2009-0010981

(51) Int. Cl. H02G 15/24

(52) U.S. Cl. 174/21 JS

(57) ABSTRACT

The gas insulated transmission line includes: a pair of conductors disposed in a length direction; a fixed-side socket and a movable-side socket respectively coupled to one ends of the conductors; and a conductive flexible member interposed between facing end surfaces of the fixed-side socket and the movable-side socket, both ends of the conductive flexible member being closely adhered to the end surfaces of the fixed-side socket and the movable-side socket to keep electric contact therebetween, and the conductive flexible member being expanded or shrunken in an axial direction according to thermal expansion/shrinkage of the pair of conductors. The gas insulated transmission line provides a wide axial contact area while allowing thermal expansion/shrinkage of conductors.

### CROSS-REFERENCE TO RELATED APPLICATION

This application claims priority to Korean Patent Application No. 10-2009-0010981, filed on Feb. 11, 2009, and all the benefits accruing therefrom under 35 U.S.C. §119, the contents of which in its entirety are herein incorporated by reference.

### BACKGROUND

1. Field

This disclosure relates to a gas insulated transmission line, and more particularly to a gas insulated transmission line having improved electric contact performance and maximized allowable current by increasing an electric contact area of connection parts of conductors.

2. Description of the Related Art

A gas insulated transmission line (GIL) or compressed gas insulated transmission line (CGIT) system is a transmission line prepared by fixing a cylindrical conductor inside a cylindrical enclosure with a gap and then filling an insulating gas composed of a mixture gas of SF6 and nitrogen (N₂) in a space between the conductor and the enclosure for insulation between them, as disclosed well in U.S. Pat. Nos. 4,743,709, 4,721,829 and 4,554,399.

Such a gas insulated transmission line is suitable for a large capacity underground line, and once installed, the gas insulated transmission line demands small maintenance costs, since it is sufficient to check it by naked eyes only once in a few years. Also, the gas insulated transmission line is suitable for downtown areas that do not easily allow installation of overhead transmission lines and demands underground installations of transmission lines.

FIG. 1 shows a schematic structure of such a gas insulated transmission line. As shown in FIG. 1, the gas insulated transmission line is configured such that a cylindrical conductor 20 having a smaller diameter and made of aluminum alloy material is disposed inside a cylindrical enclosure 10 made of aluminum alloy, the conductor 20 being supported by a fixed support insulator 30 and a movable support insulator 35 to keep a gap from the enclosure 10, and an insulating gas 50 being filled in insulating spaces partitioned by spacers 40.

Such a gas insulated transmission line is prepared as a segment 2 having a unit length (e.g., about 12 m), and such segments are connected for usage in a length direction along an installation path.

At a portion where the segments 2 of unit length are connected, conductors 20 adjacent to each other in a length direction are electrically connected to form one conductor line, thereby ensuring stable electric transmission.

However, the conductor 20 generates Joule's heat during electric transmission, and this heat causes change (increase) of temperature of the conductor 20. Thus, the conductor 20 is thermally expanded according to the temperature change.

For this reason, a conductor connector 100 is configured with a sliding contact structure to accommodate such a length change of the conductor 20, caused by thermal expansion.

FIG. 2 shows a conductor connector with a sliding contact structure (hereinafter, referred to as ‘a sliding conductor connector’).

The sliding conductor connector 100 has a fixed-side socket 110 at one end of one conductor 20a and a movable-side socket 120 at an end of an adjacent conductor 20b. A connection sleeve 130 is interposed between the fixed-side socket 110 and the movable-side socket 120. One side of the connection sleeve 130 is fixed such that it cannot move when being contacted to the fixed-side socket 110 by a fixed contact point 131, and the other side of the connection sleeve 130 is sliding-contacted to the movable-side socket 120 by a movable contact point 132. Thus, if the conductors 20 (20a, 20b) are expanded or shrunken due to heat, the movable-side socket 120 and the connection sleeve 130 make a sliding movement while keeping their electric contact.

Here, the connection sleeve 130 is fixed to the fixed-side socket 110 by means of a fixed plate 140. The fixed plate 140 has a rim portion inserted into the connection sleeve 130 and a center portion fixed to the fixed-side socket 110 by means of a coupler 141. Also, an outer side of the sliding conductor connector 110 is coated with a high pressure shield 150. One side of the high pressure shield 150 is fixed to the fixed-side socket 110 by means of a coupler 151, and a seal 160 is provided for sealing between the high pressure shield 150 and the conductors 20a, 20b.

The gap between the high pressure shield 150 and the conductors 20a, 20b is kept by means of a back-up spring 170.

In such a sliding conductor connector 100, a contact area of both conductors 20a, 20b gives a direct influence on allowable current according to heating of the conductors. For example, if the contact area is small, an amount of heating is increased due to the increase of contact resistance, and the increased amount of heating causes reduction of allowable current (namely, reduction of transmission capacity).

As a result, the sliding conductor connector 100 does not provide a sufficient contact area, which increases an amount of heat and reduces allowable electric current, although it may easily cope with thermal expansion of conductors since the socket 120 and the connection sleeve 130 are contacted in a sliding contact manner in a radial direction.

### SUMMARY

Disclosed herein is a gas insulated transmission line having improved electric contact performance and maximized allowable current by increasing an electric contact area of a sliding conductor connector.

In one aspect, there is provided a gas insulated transmission line configured by connecting segments of unit length in a length direction of the transmission line, the segment having a cylindrical conductor disposed in a cylindrical enclosure while keeping a gap from the cylindrical enclosure in a radial direction, the gas insulated transmission line including: a pair of conductors disposed in a length direction; a fixed-side socket and a movable-side socket respectively coupled to one ends of the conductors; and a conductive flexible member interposed between facing end surfaces of the fixed-side socket and the movable-side socket, both ends of the conductive flexible member being closely adhered to the end surfaces of the fixed-side socket and the movable-side socket to keep electric contact therebetween, and the conductive flexible member being expanded or shrunken in an axial direction according to thermal expansion/shrinkage of the pair of conductors.

The gas insulated transmission line may further include a connection sleeve disposed on outer peripheries of the fixed-side socket and the movable-side socket and having one side fixed to the fixed-side socket and electrically connected thereto and the other side sliding-contacted to the movable-side socket in an axial direction and electrically connected thereto.

The conductive flexible member may include a plurality of disks arranged in an axial direction and spring bridges respectively connected between adjacent disks.

The gas insulated transmission line provides a wide axial contact area while allowing thermal expansion/shrinkage of conductors, and also the gas insulated transmission line further provides an axial contact area in addition to the radial contact achieved by the existing sliding contact manner. Thus, the gas insulated transmission line may decrease an amount of generated heat and prevent reduction of allowable current of the transmission line by increasing an electric contact area at connection ports between conductors.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 is a schematic view showing a general gas insulated transmission line;

FIG. 2 shows a conductor connector with a sliding contact structure;

FIG. 3 shows a detailed configuration of a conductor connector disclosed herein; and

FIG. 4 shows that a conductive flexible member is shrunken as both conductors depicted in FIG. 3 are lengthened due the thermal expansion.

### DETAILED DESCRIPTION

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or“includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals in the drawings denote like elements. The shape, size and regions, and the like, of the drawing may be exaggerated for clarity.

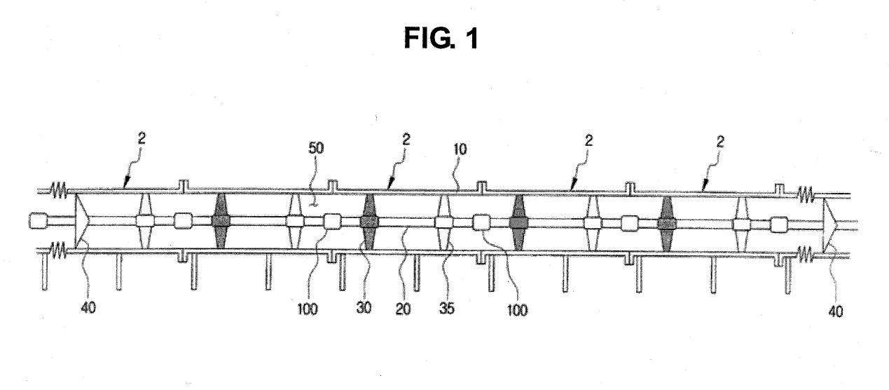

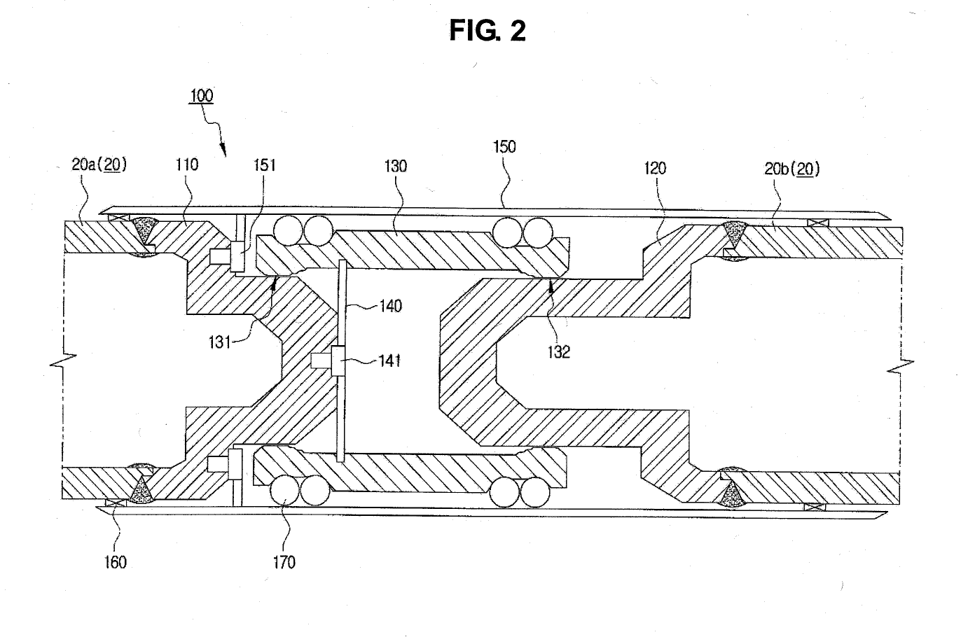

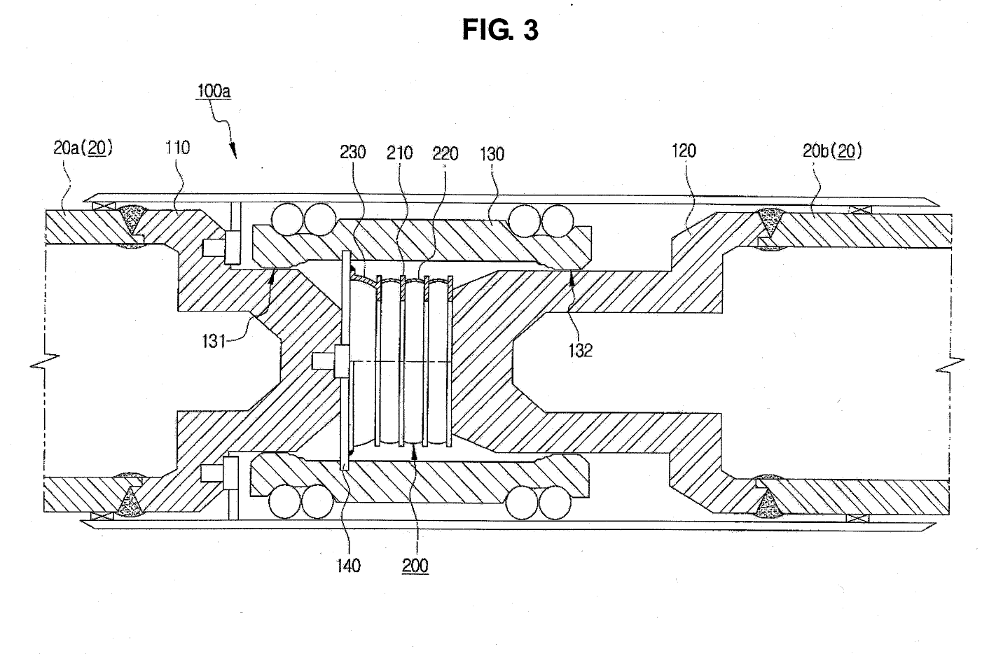

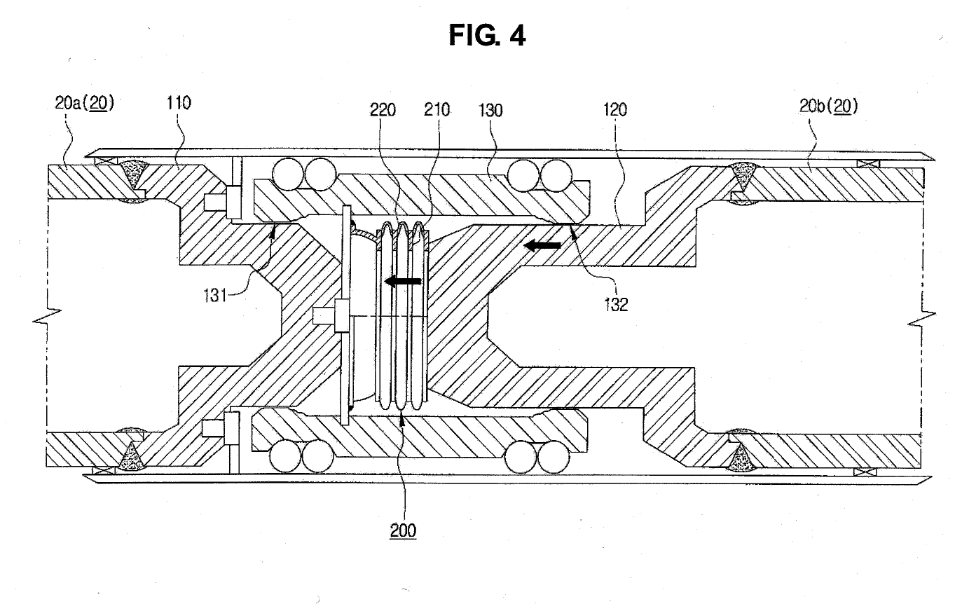

FIGS. 3 and 4 show a conductor connector disclosed herein. FIG. 3 is a sectional view showing the conductor connector in detail, and FIG. 4 shows that a conductive flexible member is shrunken as both conductors depicted in FIG. 3 are lengthened due the thermal expansion. In FIGS. 3 and 4, the same component as in FIGS. 1 and 2 are designated by the same reference numeral, and it will not be explained in detail again.

As shown in FIG. 3, a sliding conductor connector 100a disclosed herein includes a fixed-side socket 110 and a movable-side socket 120 provided at ends of adjacent conductors 20a, 20b, and a connection sleeve 130 for electrically connecting both sockets 110, 120. The connection sleeve 130 has one side fixed to an outer periphery of the fixed-side socket 110 and electrically connected thereto and the other side sliding-contacted to an outer periphery of the movable-side socket 120 and electrically connected thereto.

In particular, the sliding conductor connector 100a may further include a conductive flexible member 200.

The conductive flexible member 200 which is extendable in an axial direction is interposed between facing end surfaces of the fixed-side socket 110 and the movable-side socket 120 to electrically connect them.

For this purpose, the conductive flexible member 200 may be thermally expanded or shrunken in an axial direction according to thermal expansion/shrinkage of the conductors 20a, 20b while both ends of the conductive flexible member 200 are closely adhered to the end surfaces of the fixed-side socket 110 and the movable-side socket 120 to keep electric contact.

Thus, the sliding conductor connector 100a disclosed herein further provides an axial electric contact area caused by the conductive flexible member 200 in addition to the radial electric contact area caused by the existing sliding movable contact point 132, explained above, thereby increasing the entire contact area of the conductor connector.

In this embodiment, the conductive flexible member 200 is configured such that a plurality of disks 210 are connected by means of spring bridges 220. The spring bridges 220 are compressed due to axial load to shorten the length of the conductive flexible member 200 (see FIG. 4), and if the axial load is released, the spring bridges 220 are recovered to lengthen the conductive flexible member 200 to its original state.

The conductive flexible member 200 may be configured such that any one end surface is fixed to any one of the fixed-side socket 110 and the movable-side socket 120 or such that both end surfaces are fixed to both sockets 110, 120.

In this embodiment, the conductive flexible member 200 has a base plate 230 at one side thereof, and the disks 210 and the spring bridges 220 are subsequently connected from the base plate 230. The base plate 230 is fixed to the end surface of the fixed-side socket 110 by means of welding or the like, and an opposite front end of the base plate 230 is just closely contacted to the end surface of the movable-side socket 120 by means of elastic force of the conductive flexible member 200. However, both ends of the conductive flexible member 200 may also be fixed to the fixed-side socket 110 and the movable-side socket 120, respectively, without being limited to the illustrated example.

In this embodiment as explained above, as shown in FIG. 4, the conductive flexible member 200 electrically connects adjacent conductors 20a, 20b while allowing expansion/shrinkage in a length direction according to thermal expansion of the adjacent conductors 20a, 20b.

Thus, in addition to the radial electric contact achieved by the fixed contact point 131 and the movable contact point 132, the adjacent conductors 20a, 20b are axially electrically connected due to the conductive flexible member 200. Thus, an electric contact area is further increased, which may result in decreased contact resistance and resultantly decreased heat generation, thereby increasing allowable current.

Meanwhile, since the axial electric contact area is much wider than the contact area achieved by the sliding contact of the connection sleeve 130, because of the conductive flexible member 200, the sliding contact of the connection sleeve 130 may be unnecessary if the corresponding conductive flexible member 200 ensures sufficient axial contact.

Thus, depending on the characteristics of gas insulated transmission lines or their use environments, it is possible to use the conductive flexible member 200 alone or to use the axial contact of the conductive flexible member 200 and sliding contact of the connection sleeve 130 together.

According to the gas insulated transmission line disclosed herein, the sliding conductor connector gives a wide contact area in an axial direction while allowing thermal expansion/shrinkage of conductors. Also, the gas insulated transmission line disclosed herein further provides an axial contact area in addition to the radial contact area obtained by the existing sliding contact.

Thus, if the sliding connector disclosed herein is applied to an actual gas insulated transmission line, an electric contact area at connection parts of conductors is increased and an amount of generated heat is reduce, which may prevent reduction of allowable current and also ensure system stability and high reliability for the transmission line.

While the exemplary embodiments have been shown and described, it will be understood by those skilled in the art that various changes in form and details may be made thereto without departing from the spirit and scope of this disclosure as defined by the appended claims.

In addition, many modifications can be made to adapt a particular situation or material to the teachings of this disclosure without departing from the essential scope thereof. Therefore, it is intended that this disclosure not be limited to the particular exemplary embodiments disclosed as the best mode contemplated for carrying out this disclosure, but that this disclosure will include all embodiments falling within the scope of the appended claims.

1-4. (canceled)

5. A gas insulated transmission line configured by connecting lengthwise, along the transmission line, segments of a unit length, the length being disposed parallel to a length of the transmission line, each segment having a cylindrical conductor disposed in a cylindrical enclosure, and each conductor maintaining a radial gap from the cylindrical enclosure, the gas insulated transmission line comprising:
a pair of elongated conductors, each conductor having a length, and each length disposed parallel with a length of the transmission line;
a fixed-side socket and a movable-side socket coupled to one end of each one of the elongated conductors, each socket having at least one end surface; and
a conductive flexible member interposed between facing end surfaces of the fixed-side socket and the movable-side socket, both ends of the conductive flexible member being closely adhered to the end surfaces of the fixed-side socket and the movable-side socket to maintain electrical contact therebetween, and the conductive flexible member capable of expanding and shrinking, in a direction parallel to the transmission line, according to thermal expansion and shrinkage of the pair of elongated conductors.

6. The gas insulated transmission line according to claim 5, wherein the conductive flexible member includes a plurality of disks, arranged with the broad area of the disk oriented perpendicular to the length of the transmission line, and spring bridges connected between adjacent disks.

7. A gas insulated transmission line configured by connecting lengthwise, along the transmission line, segments of a unit length, the length being disposed parallel to the length of the transmission line, each segment having a cylindrical conductor disposed in a cylindrical enclosure, and each conductor maintaining a radial gap from the cylindrical enclosure, the gas insulated transmission line comprising:
a pair of elongated conductors, each conductor having a length, and each length disposed parallel with a length of the transmission line;
a fixed-side socket and a movable-side socket coupled to one end of each one of the elongated conductors, each socket having at least one end surface;
a conductive flexible member interposed between facing end surfaces of the fixed-side socket and the movable-side socket, both ends of the conductive flexible member being closely adhered to the end surfaces of the fixed-side socket and the movable-side socket to maintain electrical contact therebetween, and the conductive flexible member capable of expanding and shrinking, in a direction parallel to the transmission line, according to thermal expansion and shrinkage of the pair of elongated conductors; and
a connection sleeve disposed on outer peripheries of the fixed-side socket and the movable-side socket and having one side fixed to the fixed-side socket and electrically connected thereto and the other side slidably contacted to the movable-side socket and electrically connected thereto.

8. The gas insulated transmission line according to claim 7, wherein the conductive flexible member includes a plurality of disks, arranged with the broad area of the disk oriented perpendicular to the length of the transmission line, and spring bridges connected between adjacent disks.
